(19) United States
(12) Patent Application Publication
(10) Pub. No.: US 2015/0058035 A1
(43) Pub. Date: Feb. 26, 2015

(54) METHODS, SYSTEMS AND COMPUTER PROGRAM PRODUCTS FOR AUTOMATIC PERIODIC PRESCRIPTION FILL DATES

(71) Applicant: Ateb, Inc., Raleigh, NC (US)

(72) Inventors: Robbert J. Ayshford, Raleigh, NC (US); James F. Boericke, Raleigh, NC (US); Gerald Stephen Few, Raleigh, NC (US); Deborah N. Sheppard, Marco Island, FL (US); Frank P. Sheppard, Marco Island, FL (US)

(21) Appl. No.: 14/466,535

(22) Filed: Aug. 22, 2014

Related U.S. Application Data
(60) Provisional application No. 61/869,330, filed on Aug. 23, 2013.
(60) Provisional application No. 61/979,220, filed on Apr. 14, 2014.

(51) Int. Cl. G06F 19/00

(52) U.S. Cl. CPC G06F 19/3456
USPC 705/2

(57) ABSTRACT

Methods, systems and computer program products for periodically refilling one or more prescriptions for one or more patients is provided, each of the prescriptions having a days supply associated therewith. The method includes a) receiving one or more prescriptions to periodically refill, each of the one or more prescriptions having a next fill date associated therewith, wherein the next fill date is a date when the prescription was last filled incremented by a days supply for the prescription; b) receiving an alignment date selection on a processor for the one or more prescriptions; c) automatically triggering a refill of the one or more prescription on the alignment date; and d) triggering one or more action items on a processor before and/or after the alignment date.

### RELATED APPLICATIONS

This application claims priority to U.S. Provisional Application Ser. No. 61/869,330, filed Aug. 23, 2013 and U.S. Provisional Application Ser. No. 61/979,220, filed Apr. 14, 2014, the disclosures of which are hereby incorporated by reference in their entireties.

### FIELD OF THE INVENTION

The present invention relates to pharmacy management systems, methods and/or computer program products, and more specifically to systems, methods and/or computer program products that are used to calculate automatic periodic fill dates for prescriptions in pharmacies.

### BACKGROUND

Pharmacy management systems, methods and/or computer program products are widely used to run a pharmacy such as a stand-alone pharmacy and/or a pharmacy department of a larger establishment. Pharmacy management systems can handle management aspects of the pharmacy including management aspects of dispensing pharmaceutical prescriptions. Pharmacy management systems may also include an interactive voice response (IVR) system that can allow callers to access the pharmacy services by telephone when the pharmacy is open and/or when the pharmacy is closed. As is well known to those having skill in the art, a pharmacy management system, method and/or computer program product can operate on one or more stand-alone or networked computers and/or can be installed on one or more computers that provides other general functions.

Many types of medications are most efficacious when taken regularly by a patient. Despite the use of convenient IVR systems, however, many patients do not regularly refill their prescriptions. Unfilled or sporadically-filled prescriptions may result in poor compliance with medications.

### SUMMARY OF EMBODIMENTS OF THE INVENTION

In some embodiments, a method for periodically refilling one or more prescriptions for one or more patients is provided, each of the prescriptions having a days supply associated therewith. The method includes a) receiving one or more prescriptions to periodically refill, each of the one or more prescriptions having a next fill date associated therewith, wherein the next fill date is a date when the prescription was last filled incremented by a days supply for the prescription; b) receiving an alignment date selection on a processor for the one or more prescriptions; c) automatically triggering a refill of the one or more prescription on the alignment date; and d) triggering one or more action items on a processor before and/or after the alignment date.

In some embodiments, the one or more action items before and/or after the alignment date comprise at least one action item to inform the patient that the prescriptions are ready for pick up. The one or more action items may include at least one action item to confirm the refill before the alignment date. In some embodiments, the method further includes determining whether the patient has picked up the prescription within a predefined time period, and if the patient has not picked up the prescription within the predefined time period, the one or more action items comprises an action item to remind the patient that the refill pick up has been missed. In some embodiments, the method further includes repeating steps a)-d) for a plurality of patients, and periodically providing a list of the one or more action items for the plurality of patients. The one or more action items may be electronic reminders to a pharmacy staff to contact a patient. In some embodiments, the method may further include calculating one or more suggested alignment dates by determining the next fill dates for each of the one or more prescriptions and selecting the latest next fill date as a suggested alignment date.

In some embodiments, the method includes determining if any of the one or more prescriptions requires a short fill prior to the alignment date in order to supply the patient with medication until the alignment date; and if a short fill is required prior to the alignment date, calculating an amount of the short fill. The method may include filling the amount of the short fill and providing the amount of the short fill to the patient. The amount of the short fill may be provided to the patient when the patient selects the alignment date. In some embodiments, the method includes calculating a cost of the short fill prior to filling the amount of the short fill to the patient.

In some embodiments, the one or more prescriptions comprise a plurality of prescriptions, and, if a refill supply amount for one or more of the plurality of prescriptions is different, then the step of receiving an alignment date selection comprises receiving a different alignment date selection for each group of the plurality of prescriptions having the same refill supply amount. In some embodiments, the one or more prescriptions include a plurality of prescriptions, and at least one of the one or more suggested alignment dates include a refill date corresponding to a prescription with a highest copay of the plurality of prescription. The one or more prescriptions may include a plurality of prescriptions, and at least one of the one or more suggested alignment dates may include a latest refill date corresponding to a prescription with a refill date that is a latest date of the plurality of prescriptions.

In some embodiments, scoring a patient with a processor in response to prescription and/or patient data associated with the patient to provide a prescription timing benefit score, the prescription timing benefit score comprising an estimate of a degree to which the patient would increase prescription compliance when prescription fill dates of one or more prescriptions are periodically automatically refilled; and when the prescription timing benefit score satisfies a predetermined threshold score, performing steps a)-d).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram of methods, systems and computer program products according to some embodiments.

FIGS. 2-4 are flowcharts illustrating operations according to some embodiments.

FIG. 5 is a schematic diagram of scoring criteria according to some embodiments.

FIGS. 6-7 are flowcharts illustrating operations according to some embodiments.

FIGS. 8-12 are screenshots illustrating methods, systems and computer program products according to some embodiments.

FIG. 13 is a flow diagram illustrating operations according to some embodiments.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items and may be abbreviated as “/”. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block may be separated into multiple blocks and/or the functionality of two or more blocks may be at least partially integrated.

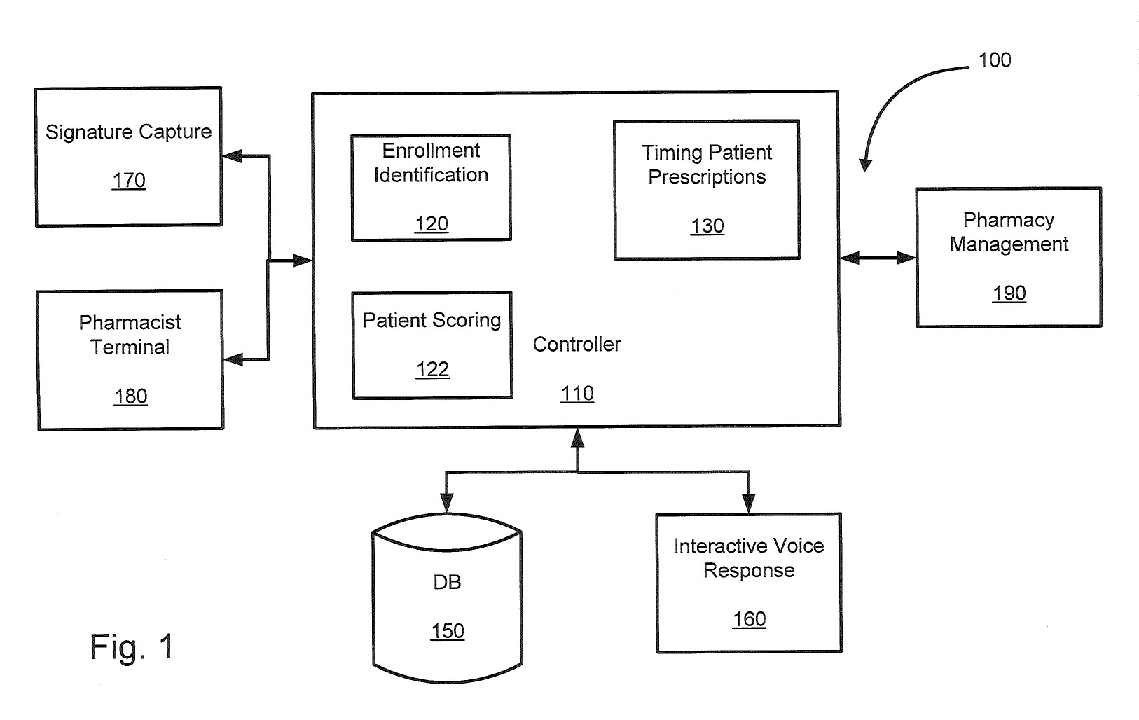

FIG. 1 is a block diagram of systems, methods and/or computer program products for operating a pharmacy according to some embodiments of the invention. As shown in FIG. 1, the pharmacy system 100 includes a controller 110 having an enrollment identification module 120, a patient scoring module 122 and a timing patient prescriptions module 130. The controller 110 may by in communication with database 150, an Interactive Voice Response (IVR) System 160, a signature capture device 170 and a pharmacist terminal 180 and/or other pharmacy management modules 190. The controller 110 may be embodied as one or more enterprise, application, personal and/or pervasive computer systems which may be connected by a network such as a local area network and/or a wide area network including the Internet. The controller 110 can coordinate interaction among the other components of FIG. 1. It will be understood that the functionality of the controller 110 can be centralized and/or distributed among the other components.

The IVR system components 160 may be coupled to one or more telephone lines to receive telephone calls from callers. The IVR system 160 can include prerecorded voice prompts such as prerecorded human voice segments, stored text-to-speech generated segments, text-to-speech segments that are generated on the fly, and/or use other conventional techniques for generating voice prompts. The pharmacy management module 190 may include computer systems and modules to manage patient records, manage doctor records, manage medication data, facilitate prescription fulfillment and/or perform other functions. Other pharmacy management systems 190 may be used to perform other pharmacy management functions.

The design and operation of the IVR system 160 and other pharmacy management systems 190 are well known to those having skill in the art and need not be described further herein. Moreover, it will be understood that the IVR system 160 and/or the other pharmacy management systems 190 may be combined to run on a single enterprise, application and/or personal computer system. Alternatively, these systems may be distributed over more than one enterprise, application, personal and/or pervasive computer systems which may be connected by a network such as a local network and/or a wide area network including the Internet.

Still referring to FIG. 1, the pharmacist terminal 180 may be used by a pharmacist to perform pharmacist functions in the pharmacy. For example, a barcode scanner also may be included and may be used by the pharmacist to identify a pharmaceutical prescription by scanning a barcode on a container (a bag, box, bottle, etc.) that corresponds to the pharmaceutical prescription. The signature capture system 170 may include one or more touch screen displays that are configured to accept a signature using a stylus and/or other device and may also include one or more keys and/or buttons (fixed and/or programmable) that may be activated by a user, for example, using a stylus and/or finger, to provide various user inputs. Various sequences of display screens may be displayed and user inputs may be accepted to provide prompt/response and/or information to a user of the signature capture system. The design and operation of a pharmacist terminal 180, a barcode scanner (not shown), and the signature capture device 170 are well-known to those having skill in the art and need not be described further herein.

The enrollment identification module 120, patient scoring module 122 and/or timing patient prescriptions module 130 are provided according to some embodiments of the present invention. The enrollment identification module 120, patient scoring module 122 and/or timing patient prescriptions module 130 may comprise hardware and/or software. It will be understood by those having skill in the art that the enrollment identification module 120, patient scoring module 122, the timing patient prescriptions module 130 and/or the database 150 may be integrated within one or more of the other components of the pharmacy system 100, in some embodiments. In other embodiments, the enrollment identification module 120, patient scoring module 122, the timing patient prescriptions module 130 and/or the database 150 may be provided on one or more enterprise, application, personal and/or pervasive computer systems that may be connected to one another using a network such as a local area network and/or a wide area network including the Internet. It will be understood by those having skill in the art that the term “database” is used herein to generically represent any kind of querying system, such as a rules engine, table, neural network, etc.

Systems, methods and/or computer program products according to embodiments of the present invention can provide the pharmacy and/or other entities an ability to calculate automatic periodic fill dates for one prescription or two or more prescriptions. In some embodiments, systems, methods and/or computer program products align fill dates of one or more prescriptions such that the fill dates periodically occur at the same time. In some embodiments, systems, methods and/or computer program products score a patient in response to prescription and/or patient data associated with the patient to provide a prescription timing benefit score. The prescription timing benefit score can be an estimate of a degree to which the patient would increase prescription compliance when prescription fill dates of one or more prescriptions are automatically periodically refilled. When the prescription timing benefit score satisfies a predetermined threshold score, the fill dates the one or more prescriptions may be automatically periodically refilled, e.g., to increase patient compliance. In some embodiments, the pharmacy system may have access to specific patient data through the pharmacy management module 190 and/or one or more databases 150. Using this data, the enrollment identification module 120 and/or the patient scoring module 122 may identify whether a patient would benefit from automatically periodically refilled prescriptions. In some embodiments, the timing benefit score allows the pharmacy to focus efforts on patients who may be likely to increase compliance if they are offered enrollment in a program that automatically periodically refills their prescriptions. The pharmacy enrolls a patient in a program that periodically refills their prescriptions (and/or the prescriptions of other members of their household), for example, by receiving information about the patient and their prescriptions and calculating periodic refill dates as described herein.

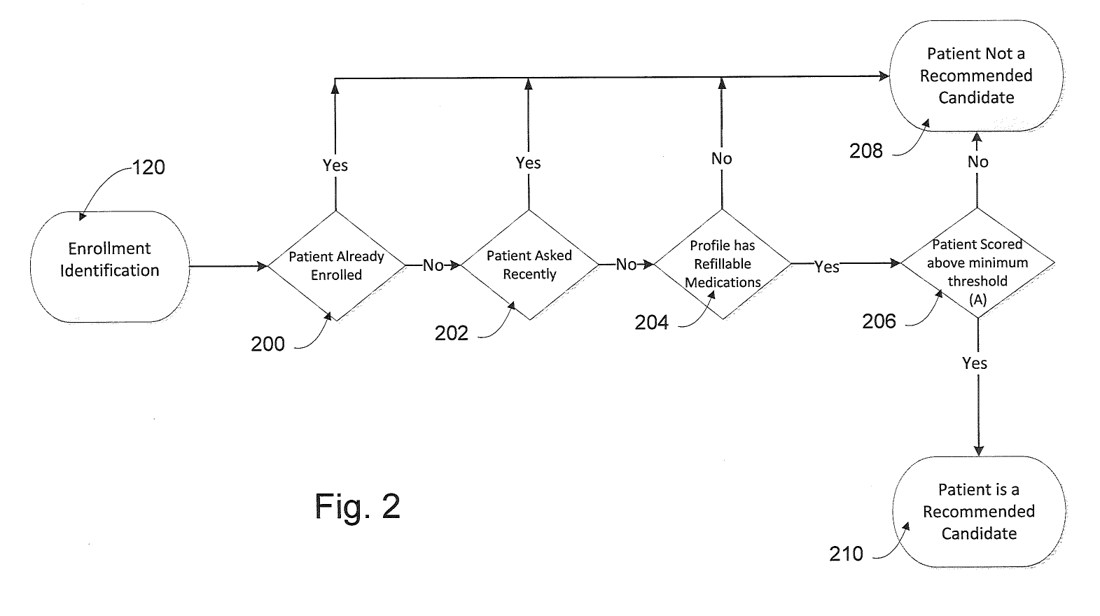

FIG. 2 is a flowchart of operations that may be performed to enroll a patient in a program that determines automatic periodic medication fill dates. As illustrated in FIG. 2, the enrollment identification module 120 can determine whether a patient is a recommended candidate for enrollment to automatically periodically refill prescriptions. The enrollment identification module 120 makes various threshold queries, such as whether the patient is already enrolled (Block 200), whether the patient has been asked to enroll recently (Block 202) and whether the patient's profile has refillable medications (Block 204). If the patient is already enrolled (Block 200), or the patient has been asked to enroll recently and declined (Block 202), or the patient profile has no refillable medications (Block 204), then the patient is identified as not a recommended candidate for enrollment (Block 208). If the patient is not already enrolled (Block 200), the patient has not been asked to enroll recently (Block 202), and the patient profile has refillable medications (Block 204), then the patient is scored or rated by the patient scoring module 122 (Block 206). If the patient is scored at a predetermined level (Block 206), such as above a minimum threshold, then the patient is identified as a recommended candidate for enrollment (Block 210). If the patient is not scored at a predetermined level (Block 206), then the patient is identified as not being a recommended candidate for enrollment (Block 208).

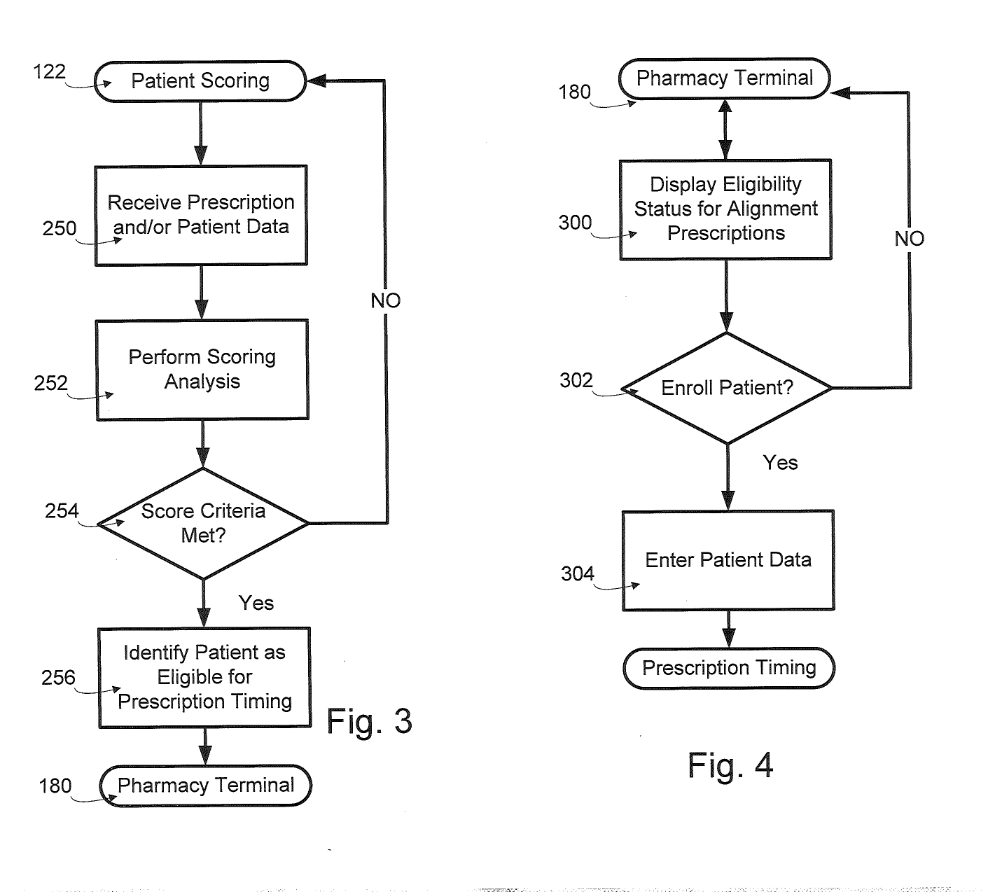

The patient score that may be calculated can be an estimate of a degree to which the patient would increase prescription compliance when prescription fill dates of one or more prescriptions are automatically periodically refilled, e.g., due to enrollment in a refill and/or reminder protocol. With reference to FIG. 3, the patient scoring module 122 can receive prescription and/or patient data (Block 250). A scoring analysis can be performed in response to the prescription and/or patient data (Block 252). If the score criteria is met (Block 254), the patient is identified as eligible or recommended for a prescription timing or periodic refill protocol (Block 256). If the score criteria is not met (Block 254), then the patient is not identified as eligible, and in some embodiments, additional patients and/or patient data may be analyzed. Although embodiments of the invention are described with respect to automatically periodically refilling prescriptions for a patient, it should be understood that the prescriptions that are automatically periodically refilled may relate to two or more patients, such as when the two or more patients are in the same household. In some embodiments, prescription records may be collated or collected and associated with a particular patient and/or related household. The operations of FIGS. 2 and 3 may be performed during a particular pharmacy transaction, such as when the patient is refilling a prescription and/or the operations of FIGS. 2 and 3 may be performed for one or more patients and/or patient records independent of a pharmacy transaction so that the pharmacist or pharmacy technicians may contact patients by any suitable technique, including direct phone calls, IVR phone calls, text messages, and the like.

With reference to FIGS. 3 and 4, if the patient is eligible for prescription refill timing alignment (Block 256), then the pharmacist terminal 180 displays the eligibility status, e.g., to the pharmacist or pharmacy technician (Block 300). The patient is provided with an opportunity to enroll in the periodic refill protocol (Block 302). If the patient agrees to enroll (Block 302), then the patient data is entered into the refill timing protocol for follow up (Block 304). In some embodiments, the patient consent is recorded in order to comply with patient confidentiality requirements, such as the Health Insurance Portability and Accountability Act (HIPAA).

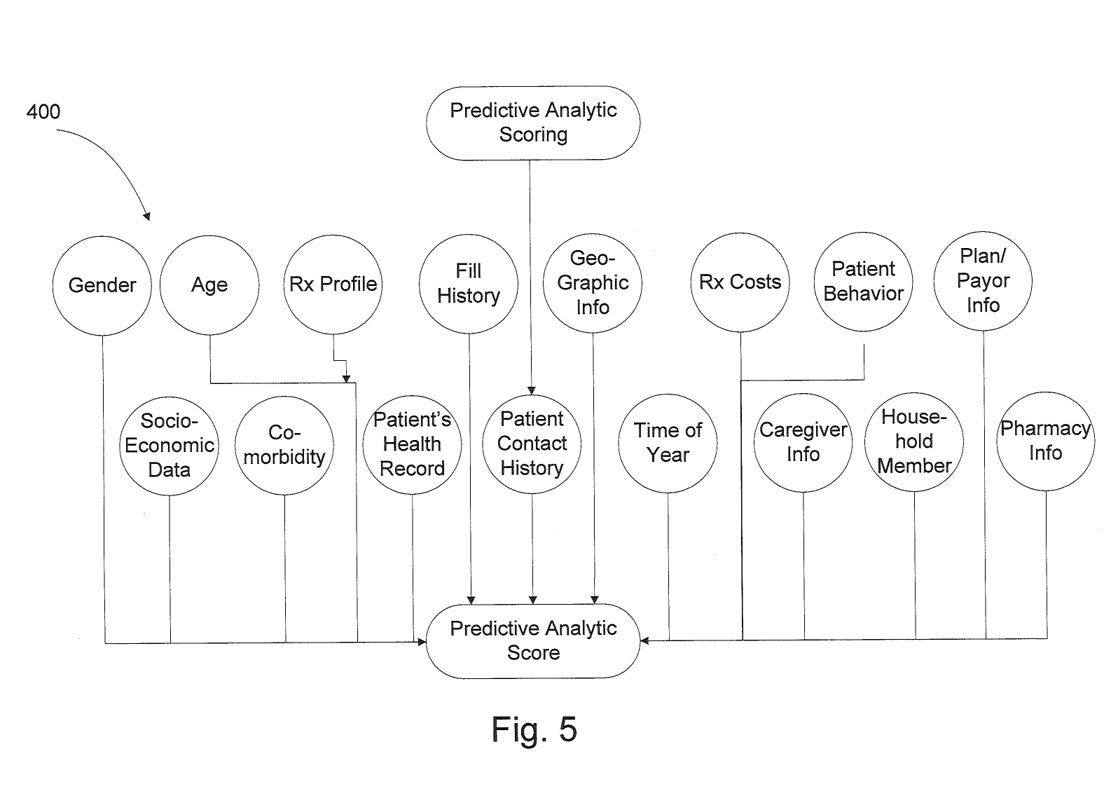

As illustrated in FIG. 5, scoring a patient to estimate a degree to which the patient would increase prescription compliance if the patient's prescriptions were automatically periodically refilled can include predictive analytic scoring. Predictive analytics may utilize a variety of techniques from statistics, modeling, machine learning and/or data mining to analyze current and/or historical data to forecast or make predictive scores about future events, such as a degree to which a patient may increase prescription compliance when enrolled in a prescription timing alignment protocol. The predictive analytic score may be determined by predetermined criteria 400 including, for example, the patient's gender, age, prescription profile (prescription data, including the type of prescription), the prescription filling history, the patient's geographic information, the prescription costs, the patient's behavior, the patient's payor or insurance information, socio-economic data, health data (including the co-morbidity of other conditions), the patient's health records, the contact history of the patient by the pharmacy or other health care professionals, the time of year, the patient's caregiver information, an identification of other members of the patient's household and/or information about the pharmacy where the patient fills prescriptions. The patient's behavior can include the patient past refilling history with respect to timeliness, including the number of days late to pickup, consistency of being late, the duration of lapses in pickups, the percentage of on time prescription pickups, the likelihood that the patient will pick up a certain type of medication as compared to other types of medication (including the behavior of picking up multiple medications when certain other medications are due or overdue), a responsiveness to other initiatives (e.g., patients that perform well in an automatic refill program may be good candidates for medication alignment), and the patient's pattern(s) of filling prescriptions such as the time of the month (beginning, middle or end) or days of the week. Regression models to establish a mathematical equation that represent statistical interactions between different variables may be used as would be understood by those of skill in the art. Regression models include linear regression models (multivariate regression), discrete choice models, logistic regression models, multinomial logistic regression models, probit regression models, time series models, survival analysis or time to event analysis, classification and regression trees, multivariate adaptive regression splines (MARS). Machine learning techniques can include those techniques known to those of skill in the art, including neural networks, multilayer perceptron, radial basis functions, support vector machines, naïve bays conditional probability rule, nearest neighbor algorithms, and geo spatial predictive modeling.

In particular embodiments, the predictive patient score that estimates a degree to which a patient may increase compliance when prescriptions fill dates are automatically periodically refilled includes providing compliance benefit information for two or more patients. The compliance benefit information includes patient data and an indication of a change in prescription compliance when fill dates of one or more prescriptions are automatically periodically refilled. A compliance benefit model may be created based the compliance benefit information for predicting which patients will increase prescription compliance when the fill dates of one or more prescriptions are automatically periodically refilled. The compliance benefit model can be created by regression analysis of the compliance benefit information. The prescription timing benefit score can be based on the compliance benefit model and is a prediction of a relative likelihood that a patient will increase prescription compliance when the fill dates of one or more prescriptions are automatically periodically refilled.

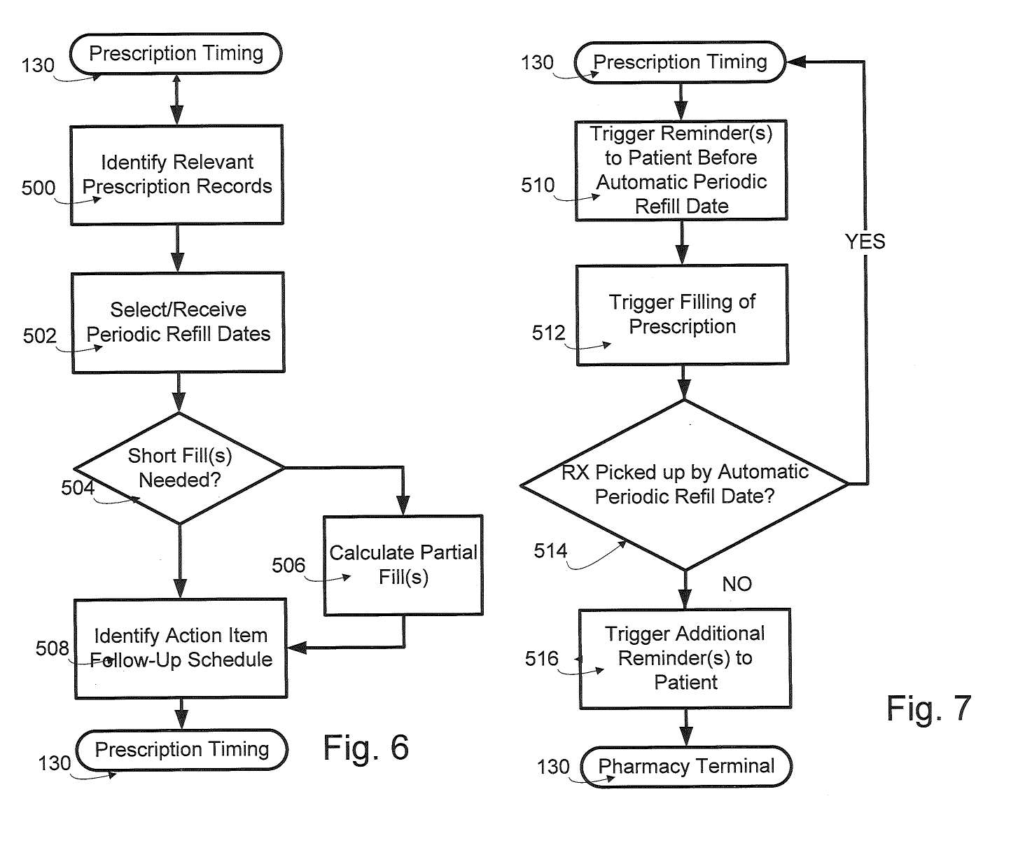

As illustrated in FIG. 6, the prescription timing module 130 can calculate automatic periodic fill dates for one or more prescriptions as follows. One or more prescription records associated with the patient and/or other household members of the patient are identified (Block 500). Automatic periodic fill dates are selected and/or received (such as received by a processor as an input) for the one or more prescription records (Block 502). Optionally, the prescription timing module 130 may calculate any short fills if the days supply of the prescription is less than or greater than a time period between a last fill date and a next fill date such as the automatic periodic fill date. A “short fill” generally refers to deliberately filling only part of a prescription without an intention to provide the remaining portion of the prescription. In contrast, a “partial fill” generally indicates that the pharmacy only had a limited inventory, and consequently, gave the patient an initial partial supply with the intent to give the patient the rest of the supply when the drug becomes available. For example, if the time period between the last fill date and the automatic periodic fill date is greater than the days supply of the prescription, then a short fill may be calculated and provided to the patient. In this case, the short fill would generally have a days supply equal to a difference between the days supply of the prescription and the time period between the last fill date and the first automatic fill date, and the short fill may be immediately provided to the patient, e.g., during the alignment process. If the time period between the last fill date and the automatic periodic fill date is less than the days supply of the prescription, then a short fill may be calculated that has a days supply generally equal to the number of days between the last fill date and the first automatic fill date. The short fill may be provided to the patient immediately during the alignment process or at a date between the last fill date and the first or second automatic fill dates. When a short fill of a prescription facilitates a selected periodic fill date (Block 504), the short fill(s) are calculated (Block 506). An action item or follow-up schedule is identified (Block 508). The action item(s) may include reminders before and/or after the automatic fill dates and may be provided to pharmacy staff by a computer system or automatically executed, for example, by one or more elements in the system described in FIG. 1.

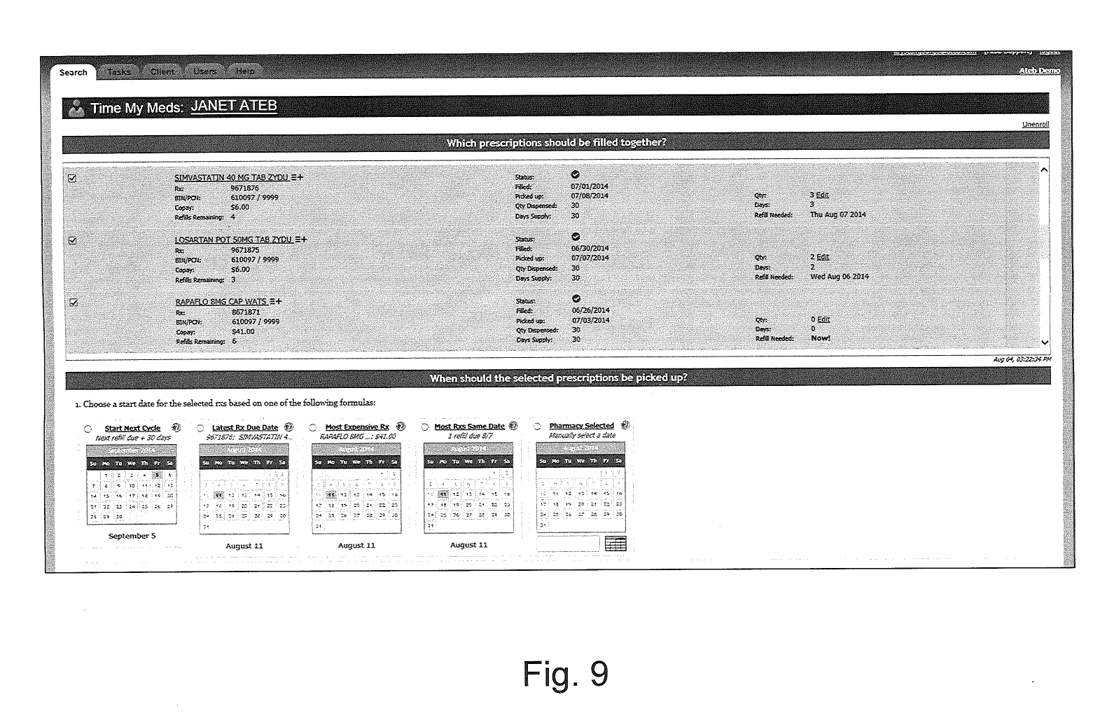

In some embodiments, the prescription records eligible for automatic periodic refills may be displayed, for example, as shown in FIG. 9. If a prescription meets certain predetermined criteria indicating that the prescription is a good candidate for automatic periodic refills, then the prescription may displayed with a recommendation that the prescription be selected for automatic periodic refills. However, the user may select the prescriptions that will be automatically and periodically refilled, and in some embodiments, the user may choose to select prescriptions for automatic and periodic refills independently of the recommendation. Therefore, the user may (or may not) select prescriptions that are recommended for automatic periodic refills, and the user may (or may not) select prescriptions that are not recommended for automatic periodic refills. Accordingly, the prescriptions that are automatically and periodically refilled may include both recommended and not recommended prescriptions. Prescriptions that are not recommended for periodic refill may include those that are not refillable and/or prescriptions that are taken on an “as needed” basis, such as allergy medication. In some embodiments, the prescriptions that are not refillable or not recommended for automatic refills may also be visually indicated on the display screen. Prescriptions that are not refillable may include, for example, controlled substances or antibiotics that are not refillable and may be ineligible for an automatic refill program or prescriptions for which the prescriber has not authorized any (or limited) refills.

The user may select an alignment period for the prescriptions and/or a start date for the first refill. As used herein, a “supply length” or “days supply” refers to a standard period or length of a prescription as prescribed by a prescribing health care provider. For example, a thirty day supply for a once a day pill would be thirty pills. If all of the prescriptions are for the same number of days supply, then the alignment period may be automatically set as the number of days supply from each selected medication. In particular embodiments, the user may select multiple prescriptions onto a single cycle. The cycle may have a minimum cycle length (e.g., 28 days). The prescription timing module 130 may display a warning if prescriptions whose cycle length is less than the cycle or up to a certain number of days greater than the cycle. The user may choose to ignore the warning and continue to add the prescription for automatic refills, or the user may remove the prescription from selection based on the warning. Prescriptions with a supply length that is greater than the current cycle may be ineligible for grouping together for alignment and may be provided with their own cycle length. Multiple alignment cycles may be identified for a single patient or customer. If all medications have a supply length that is a multiple of other medications, then the shortest days supply may be selected for the alignment period. Those with a longer days supply are still set to a alignment period based on the relevant number of days supply, but may be set to align with a future alignment date. For example, if two medications with a thirty day supply, a medication with a sixty day supply, and a medication with a ninety day supply are selected, all four may be aligned such that the start date for all of the medications is the same. The medications with a thirty day supply are filled every thirty days, the medication with a sixty day supply is filled only at multiples of sixty days, and the medication with the ninety day supply is filled only at multiples of ninety days.

If there is a supply day mismatch between prescriptions, then the user may be visually alerted on the display screen. For example, if the user tries to align a prescription with a thirty day fill period and a prescription with a twenty-eight day fill period, then a warning may be displayed. The user may select whether to include the mismatched medications together and may also select the desired period. For example, the user may refill the twenty-eight day prescription every thirty days in order to align with the thirty day supply prescription.

The automatic periodic refill dates, however, may be based on any suitable factor or factors. In some embodiments, the automatic periodic refill dates may be based on minimizing the amount of partial refills needed to synchronize more than one prescription. The automatic periodic refill dates may also be based on other factors. For example, a pharmacy that delivers prescriptions directly to a patient may determine suggested refill dates based on the efficiency of delivery routes of the pharmacy to synchronize filling prescriptions from patients on a particular delivery route. Other factors include economic factors of the pharmacy such as filling prescriptions at a particular time of the month to facilitate reimbursements, and/or advising patients to avoid patient out-of-pocket expenses. Suggested refill dates may be selected in order to more effectively manage inventory, such as with respect to more expensive medications.

In some embodiments, the estimated costs to the patient for the prescriptions at the next synchronization date may be calculated after the medications and corresponding alignment periods are selected by the user. The user may be given the option to change the synchronization dates, for example, to spread the cost of the prescriptions over a longer period of time by having two or more off-set synchronization dates. In some embodiments, the estimated costs to the patient for the prescriptions may be used to calculate and provide suggested alignment dates. For example, a refill date corresponding to a prescription with a highest copay of a group of prescriptions may be provided or suggested to the user, which may reduce the costs of short fills.

In some embodiments, an alignment date may be suggested to the user that corresponds to a latest refill date corresponding to a prescription with a refill date that is a latest date of a group of prescriptions. For example, if the current date is Day 0, and the patient has three 30-day prescriptions A, B and C that were last fill on Day −20 (Prescription A), Day −15 (Prescription B), and Day −1 (Prescription C). Then, the prescriptions are each due for a refill on Day 10 (Prescription A), Day 15 (Prescription B) and Day 29 (Prescription C). The last refill date (Day 29) may be selected as a recommended first aligned refill date to refill all of the prescriptions. Prescription A would need a partial refill of 19 days and Prescription B would need a partial refill of 14 days in order to provide the patient with a continuous supply of the prescription.

As another example, an alignment date may be calculated by determining on which day the most prescriptions are due in order to minimize the number of short fills required to get all the prescriptions aligned. For example, five 30-day prescriptions are selected A (due on the 22nd), B, C, D (due on the 28^{th}), and E due on the 5^{th} of the following month). The alignment date would be selected as the 28^{th} because three prescriptions all come due on that date. A further variant of this date is to select a neutral date that aligns with none of the existing prescriptions but would allow the pharmacy to fill the most number of prescriptions without having to perform short fills. In the immediately preceding example, the pharmacy could select an alignment date of the 23^{rd} and process full fills of medications A, B, C, and D and only have to fill a short fill of prescription E. This is because pharmacies are generally allowed to fill prescriptions up to a predetermined number of days early (typically five days early) for patients. Hence, a date that reduces the need for short fills across all selected prescriptions may include filling some prescriptions a day or two late and others up to 5 days early.

As another example, the prescriptions and available alignment dates may be reviewed to reduce the total cost to the patient by reducing or eliminating as many short fills as possible and/or finding the cheapest short fills. For example, many pharmacies give away or sell very inexpensively many generic medications. One or more suggested alignment date(s) may be selected such that across all medications, the co-pay associated with short fills are reduced or minimized, for example, by selecting an alignment date that generally coincides with the next refill date of prescriptions for which short fills are expensive while allowing short fills for prescriptions that may be inexpensive to short fill in order to reduce or eliminate the cost of short fills.

As another example, the suggested alignment day may be selected based on pharmacy activity. For example, a pharmacy routinely does diabetes workshops during the second week of each month. For patients with one or more diabetes medications being aligned, the pharmacy may select an alignment date that corresponds with the monthly diabetes workshops.

Once the pharmacist finalizes the prescriptions to synchronize and has selected the synchronization period, a synchronization start date may be selected for filling all of the prescriptions on the same synchronization period. In some embodiments, a default start date may be selected, for example, based on the first available date that the prescriptions could be posted or the date by which all of the selected medications would be finished based on the supply length of the prescriptions.

In some embodiments, the prescription timing module 130 may track two aspects of the prescription number of days supply: 1) the number of days supply for which the prescription was last filled, and 2) the remaining number of days supply, which may be based on either a number entered by a user or a calculated number of days supply remaining that is calculated based on the sold date of each prescription and the current date. In some embodiments, the default synchronization start date is calculated as the earliest available date that permits a predetermined set of refill reminders or follow-up schedule.

The follow-up schedule can include one or more reminder action items for the pharmacy staff and/or computer system(s) to interact with the patient at dates before one of the automatic periodic refill date and/or a prescription fill trigger at a date before the automatic periodic refill date. As illustrated in FIG. 7, the prescription timing module 130 can trigger reminders to a patient before the automatic periodic refill date (Block 510). The reminders may be sent to the patient by various media, including voice messages via the IVR system 160 (FIG. 1), electronic messages (text messages on a mobile device, email messages and the like) and/or in-person telephone calls made by a pharmacist or other pharmacy employee. The prescription timing module 130 can also trigger the filling of the prescription (Block 512), for example, a predetermined number of days before the calculated synchronization date so that the prescription is automatically refilled without requiring that the patient contact the pharmacy directly. If the prescription is picked up by the calculated automatic periodic refill date (Block 514), then the prescription timing module 130 proceeds to the next prescription cycle, such as the next thirty day cycle for thirty day prescriptions. If the prescription is not picked up by the patient by the automatic periodic refill date or a predetermined date after the automatic periodic refill date (Block 514), then additional reminders may be triggered to the patient (Block 516).

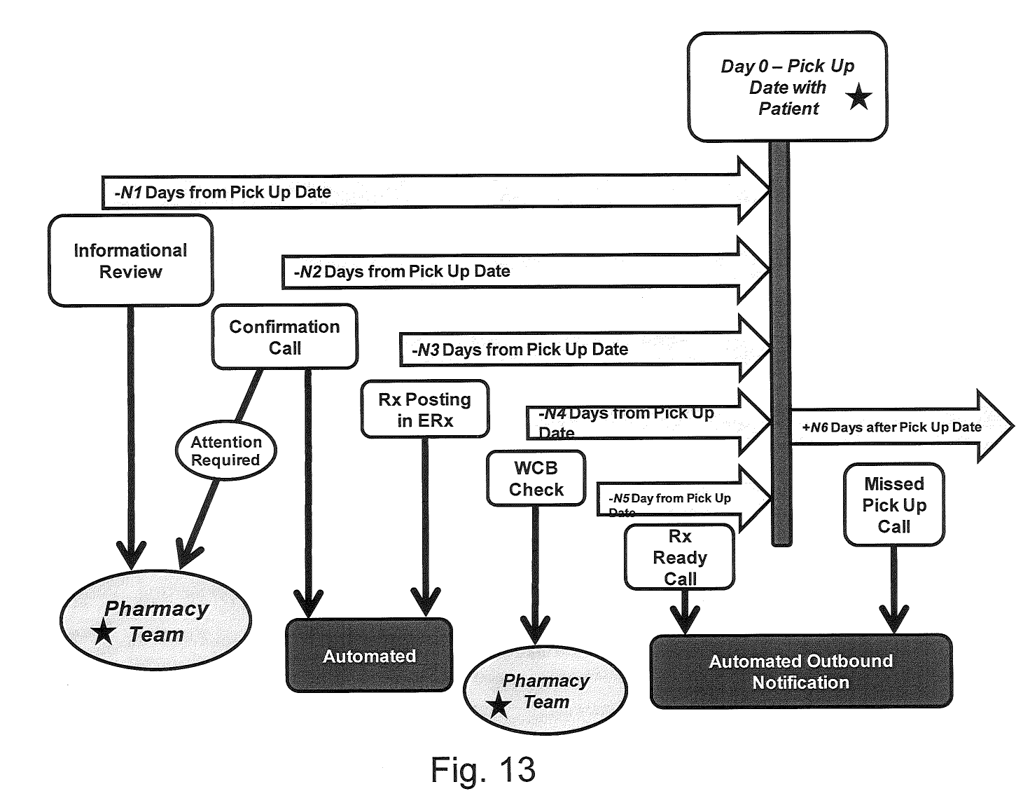

An exemplary follow-up schedule of possible action items is illustrated in FIG. 13. As illustrated in FIG. 13, at N1 days from the synchronization date or pick-up date, the prescription timing module 130 issues a reminder to the pharmacy team to have an informational review of the prescriptions. The informational review allows the pharmacy to determine if discussions with the patient should occur. For example, the pharmacist may note that the patient is taking a prescription that is designated as a “high risk” medication, which may be replaced with a lower risk medication. The pharmacy may also note that the patient is missing a medication that would usually be taken or indicated for use by the medications that the patient is taking. Accordingly, the informational review may include a manual review of the patient's records so that the pharmacy team may proactively manage the patient and/or identify any appropriate health interventions. At N2 days before the pick-up date, a confirmation call to the patient is initiated either by an automatic call or by reminding the pharmacy team to call the patient. The confirmation call may include the pharmacy asking the patient if anything has changed since their last alignment or pick up date. If changes are identified, the pharmacy has an opportunity to make those changes so that any changes or modifications are in order when the patient receives his or her medication (in some embodiments, about a week after the confirmation call). At N3 days before the pick-up date, the prescription is posted as ready for the pharmacy team to automatically refill the prescription. At N4 days before the pick-up date, a reminder is sent to the pharmacy team to verify that the prescription has been filled or an automated call is delivered, and at N5 days from the pick-up date, a call is made to the patient that the prescription is ready. If the prescription is not picked up by the patient by N6 number of days past the pick-up date, then additional calls are made either by an automated calling service or by the pharmacy team.

Although embodiments according to the present invention are described with respect to scoring and/or identifying a patient for enrollment to automatically refill prescriptions, it should be understood that one or more prescriptions may be aligned without necessarily scoring/identifying the patient, for example, as described in FIGS. 3 and 4.

In some embodiments, the operations of FIGS. 6 and 7 may be repeated to set up periodic automatic refills for a plurality of patients. The patients may optionally be identified as described with respect to FIGS. 3 and 4. The action items, such as the reminder triggers discussed with respect to FIG. 7, may be provided to the pharmacy staff and/or via computer implemented methods periodically. For example, a computer system may generate a list of all of the patients who have outstanding action items associated with them once or twice (or more) times a day or a number of times per week.

In some embodiments, the recurring dates of an automatic periodic refill date includes two or more dates, each of the synchronization dates being associated with a period refill of the two or more prescriptions. Thus, prescriptions with different refill periods (e.g., 28 days, 30 days and 90 days are typical refill periods) may be synchronized to the same or different automatic periodic refill dates. In particular embodiments, the prescriptions with different refill periods are not synchronized with one another. For example, all of the refills having a 30 day refill period may be synchronized with one another, and all of the refills with a 90 day refill period are synchronized with one another but are not synchronized with the 30 day refill period prescriptions. The automatic periodic refill date can be a recurring calendar date, e.g., a date that is based on a time period in the calendar such as the first Monday of the month, to generally encourage the patient to remember to pick up his or her prescriptions at a particular recurring time of the month. In particular embodiments, the time period in the calendar that is set as the automatic periodic refill date does not change even if the patient does not refill the prescription by the calculated refill date.

Without wishing to be bound by any particular theory, by automatically periodically refilling the patient's prescription, medication compliance may be increased. The patient may become accustomed to getting his or her prescriptions refilled, for example, at a certain time of the month without needing to contact the pharmacy to initiate the refill. In some embodiments, the pharmacy is proactively reaching out to the patient and managing the patient's care, such as by suggesting health interventions or alternative medications, instead of relying on the patient to initiate a refill. The pharmacy/patient interaction may create an accountability or incentive to drive adherence to the refill schedule and better medication compliance. This behavior may be understood according to a transtheoretical change behavior model (precontemplation, contemplation, preparation, action and maintenance). The automation of the pharmacy team action items or reminders to complete the action items may allow the alignment techniques to be performed for a relatively large number of patients and/or to proactively manage patients. Moreover, patients may be scored, for example, using predictive analytics, to determine if their compliance is likely to increase when their prescription(s) are periodically and automatically refilled.

In particular embodiments, the action items, such as the reminder triggers and refill triggers discussed with respect to FIG. 7, may be based on customized or semi-customized characteristics of the patient. For example, a patient who has had very poor compliance with refilling medication may receive more reminders than a patient who has had better compliance. Moreover, additional event triggers may be used, such as a prompt for the pharmacist to provide information to the patient, e.g., to encourage medication compliance and/or advise the patient as to the consequences of noncompliance.

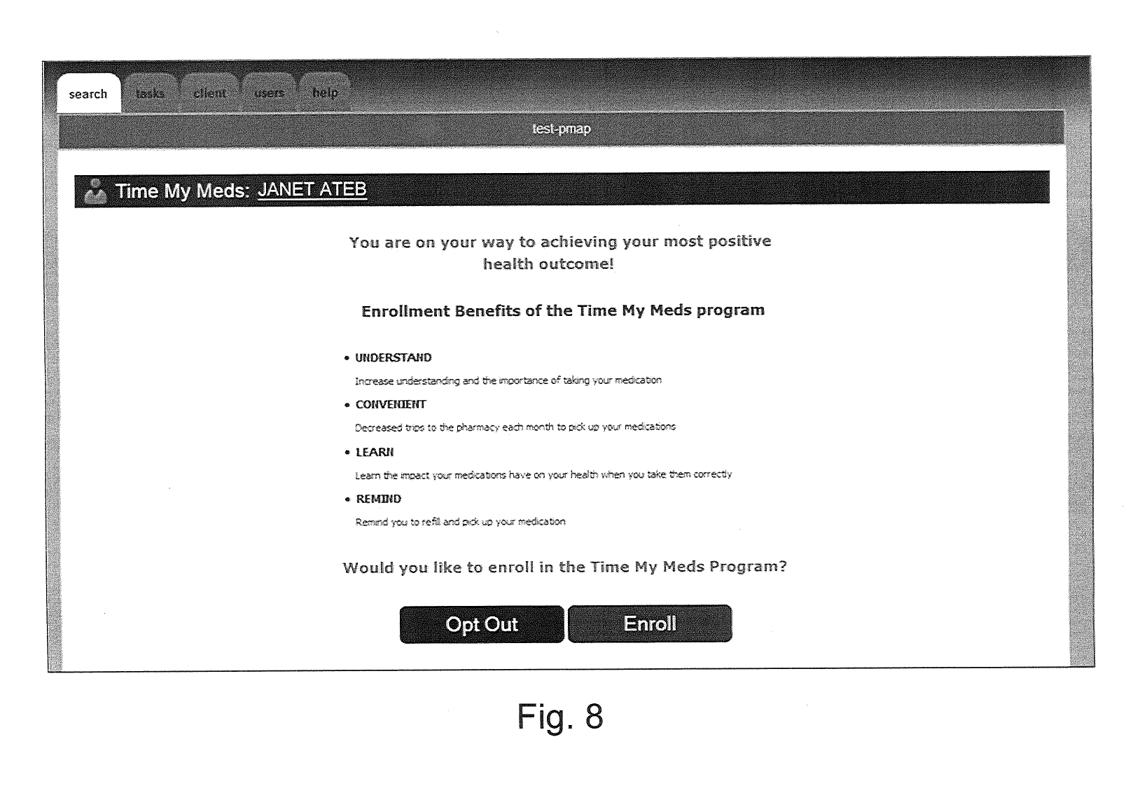

As shown in FIG. 8, when a patient has been identified for enrollment, for example, as illustrated in FIG. 2, the pharmacy terminal may display an enrollment screen. As illustrated, the enrollment screen provides information about the periodic refill protocols including a list of benefits to the patient. The patient then has the option of either enrolling in the periodic refill protocol program or opting out. As illustrated in FIG. 9, if the patient has opted to enroll in the refill protocol, the pharmacist can select which prescriptions associated with the patient and/or the patient together with other members of the patient's household should be included in the periodic refill program. For example, the pharmacist can select all of the prescriptions with the same refill period (e.g., all of the 30 day prescriptions) to be in the periodic refill program.

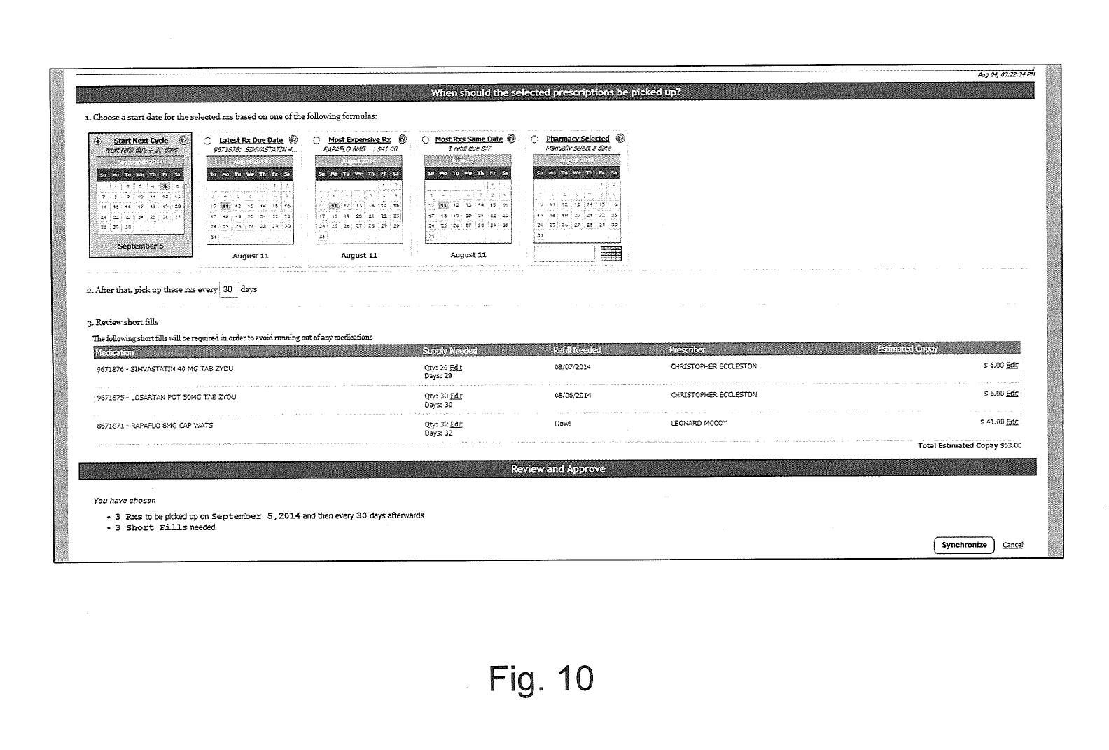

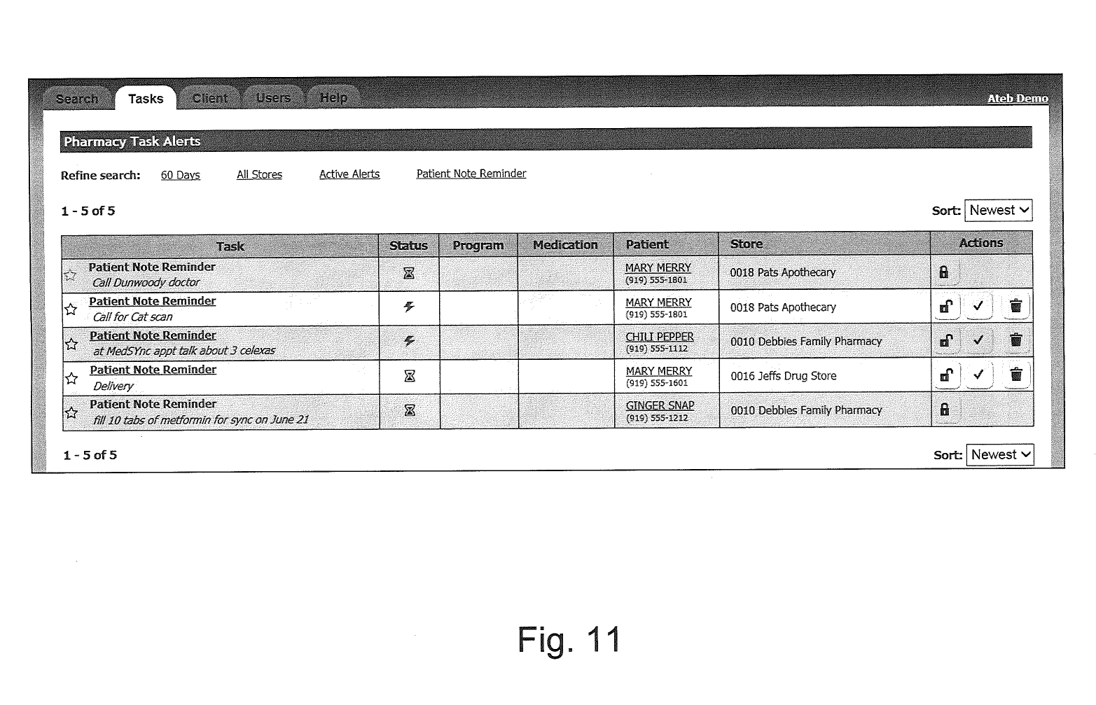

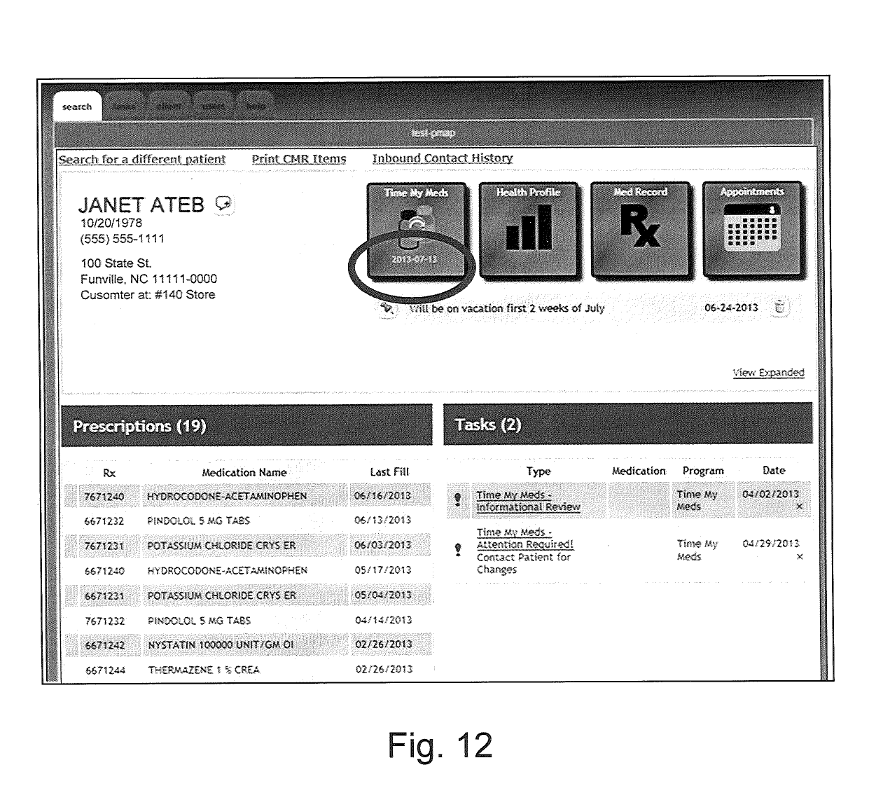

As shown in FIG. 10, the pharmacist can review the prescriptions and then select an icon to synchronize the prescriptions. As illustrated in FIG. 11, the pharmacy terminal displays all of the synchronized prescriptions and the proposed synchronization or automatic periodic refill date for confirmation by the pharmacist and/or patient. In some embodiments, the patient can modify the refill dates, e.g., if the patient prefers a different time or periodic date. As shown in FIG. 12, the pharmacy terminal then displays the pharmacy information regarding the automatic periodic refill, e.g., including the next refill date, the prescription information, and the task(s) for the pharmacy, such as when to provide the patient with reminders and/or when to fill the prescription. Although embodiments according to the invention are described in FIGS. 8-12 as displaying information on a pharmacy terminal, it should be understood that the same or similar information and options may be displayed to the pharmacy patient directly on a home computer or portable electronic device, such as a smart phone.

In some embodiments, the prescription timing module 130 may also provide the pharmacy team with information to review with the patient, for example, about the benefits of taking his or her medication regularly and adhering to medication synchronization. The prescription timing module 130 may provide the pharmacy team with forms to confirm that the patient is choosing to enroll in a synchronization program. Worksheets may also be used to list short fills that the pharmacy may prepare in order for the patient to have access to medication until the first alignment start date. Information may also be sent to the doctor or other prescriber informing them of the benefits of the alignment program. In some embodiments, the prescription timing module 130 may also send the prescriber a refill authorization form that requests that the prescriber authorize a new prescription for the patient so that all of the alignment prescriptions expire at around the same time (for example, within a month).

In some embodiments, the alignment dates may or may not be the same for each of the alignment medications, which may provide additional flexibility in creating multiple alignment cycles for the same patient or household, for example, if a patient cannot afford to align all of the prescriptions at the same time or if the patient has medications that are not filled for the same number of days supply.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for periodically refilling one or more prescriptions for one or more patients, each of the prescriptions having a days supply associated therewith, the method comprising:
a) receiving one or more prescriptions to periodically refill, each of the one or more prescriptions having a next fill date associated therewith, wherein the next fill date is a date when the prescription was last filled incremented by a days supply for the prescription;
b) receiving an alignment date selection on a processor for the one or more prescriptions;
c) automatically triggering a refill of the one or more prescription on the alignment date; and
d) triggering one or more action items on a processor before and/or after the alignment date.

2. The method of claim 1, wherein the one or more action items before and/or after the alignment date comprise at least one action item to inform the patient that the prescriptions are ready for pick up.

3. The method of claim 2, wherein the one or more action items comprise at least one action item to confirm the refill before the alignment date.

4. The method of claim 3, further comprising determining whether the patient has picked up the prescription within a predefined time period, and if the patient has not picked up the prescription within the predefined time period, the one or more action items comprises an action item to remind the patient that the refill pick up has been missed.

5. The method of claim 4, further comprising: repeating steps a)-d) for a plurality of patients, and periodically providing a list of the one or more action items for the plurality of patients.

6. The method of claim 5, wherein the one or more action items are electronic reminders to a pharmacy staff to contact a patient.

7. The method of claim 1, further comprising calculating one or more suggested alignment dates by determining the next fill dates for each of the one or more prescriptions and selecting the latest next fill date as a suggested alignment date.

8. The method of claim 1, further comprising:
determining if any of the one or more prescriptions requires a short fill prior to the alignment date in order to supply the patient with medication until the alignment date; and
if a short fill is required prior to the alignment date, calculating an amount of the short fill.

9. The method of claim 8, further comprising filling the amount of the short fill and providing the amount of the short fill to the patient.

10. The method of claim 9, wherein the amount of the short fill is provided to the patient when the patient selects the alignment date.

11. The method of claim 9, further comprising calculating a cost of the short fill prior to filling the amount of the short fill to the patient.

12. The method of claim 1, wherein the one or more prescriptions comprise a plurality of prescriptions, and, if a refill supply amount for one or more of the plurality of prescriptions is different, then the step of receiving an alignment date selection comprises receiving a different alignment date selection for each group of the plurality of prescriptions having the same refill supply amount.

13. The method of claim 7, wherein the one or more prescriptions comprise a plurality of prescriptions, and at least one of the one or more suggested alignment dates comprises a refill date corresponding to a prescription with a highest copay of the plurality of prescription.

14. The method of claim 7, wherein the one or more prescriptions comprise a plurality of prescriptions, and at least one of the one or more suggested alignment dates comprises a latest refill date corresponding to a prescription with a refill date that is a latest date of the plurality of prescriptions.

15. The method of claim 1, further comprising scoring a patient with a processor in response to prescription and/or patient data associated with the patient to provide a prescription timing benefit score, the prescription timing benefit score comprising an estimate of a degree to which the patient would increase prescription compliance when prescription fill dates of one or more prescriptions are periodically automatically refilled; and when the prescription timing benefit score satisfies a predetermined threshold score, performing steps a)-d).

16. A computer program product for periodically refilling one or more prescriptions for one or more patients, each of the prescriptions having a days supply associated therewith, the computer program product comprising a computer usable storage medium having computer-readable program code embodied in the medium, the computer-readable program code comprising:
a) computer readable program code that is configured to receive one or more prescriptions to periodically refill, each of the one or more prescriptions having a next fill date associated therewith, wherein the next fill date is a date when the prescription was last filled incremented by a days supply for the prescription;
b) computer readable program code that is configured to receive an alignment date selection on a processor for the one or more prescriptions;
c) computer readable program code that is configured to automatically trigger a refill of the one or more prescription on the alignment date; and
d) computer readable program code that is configured to trigger one or more action items on a processor before and/or after the alignment date.

17. The computer program product of claim 16, wherein the one or more action items before and/or after the alignment date comprise at least one action item to inform the patient that the prescriptions are ready for pick up.

18. The computer program product of claim 17, wherein the one or more action items comprise at least one action item to confirm the refill before the alignment date.

19. The computer program product of claim 18, further comprising computer readable program code configured to determine whether the patient has picked up the prescription within a predefined time period, and if the patient has not picked up the prescription within the predefined time period, the one or more action items comprises an action item to remind the patient that the refill pick up has been missed.

20. A system for periodically refilling one or more prescriptions for one or more patients, each of the prescriptions having a days supply associated therewith, the system comprising:
a patient alignment module configured to receive one or more prescriptions to periodically refill, each of the one or more prescriptions having a next fill date associated therewith, wherein the next fill date is a date when the prescription was last filled incremented by a days supply for the prescription; to receive an alignment date selection on a processor for the one or more prescriptions; to automatically trigger a refill of the one or more prescription on the alignment date; and to trigger one or more action items on a processor before and/or after the alignment date.
